(19) United States
(12) Patent Application Publication
(10) Pub. No.: US 2014/0258050 A1
(43) Pub. Date: Sep. 11, 2014

(54) Store Feature Item Finder

(71) Applicant: WAL-MART STORES, INC., Bentonville, AR (US)

(72) Inventors: Issa Mohamad Abboud, Cave Springs, AR (US); Robert C. Taylor, Rogers, AR (US)

(73) Assignee: WAL-MART STORES, INC., Bentonville, AR (US)

(21) Appl. No.: 13/787,887

(22) Filed: Mar. 7, 2013

(51) Int. Cl. G06Q 10/08

(52) U.S. Cl. CPC G06Q 10/087
USPC 705/28

(57) ABSTRACT

A system and method of selecting items from an inventory for stocking a display in an enterprise includes receiving a request over a network from a user device to stock a display in the enterprise with items. A type of the display is ascertained. Inventory is analyzed to determine one or more types of items that are available in the inventory and suitable, based on one or more selection criteria, for stocking the type of the display. A response to the request is sent to the user device identifying, based on the analysis of the inventory, each type of item determined to be available in the inventory and suitable for stocking the display.

### FIELD OF THE INVENTION

The present invention relates generally to inventory searching for items to maximize usage of item displays in enterprises.

### BACKGROUND

The current process for stocking or re-stocking a display in an enterprise such as a department or grocery store involves manually searching through available inventory in the stockroom in the store. If the same item is not available for re-stocking, a substitute item must be found, and only guesswork can be used to know if the available items will fit properly in the display. Furthermore, the process of manual re-stocking cannot take into account sales lift or profitability of items that might be selected for display; therefore, potential sales and profit are lost. There is a need for more intelligent processes for inventory searching to maximize the usage of display space in enterprises.

### SUMMARY

All examples and features mentioned below can be combined in any technically possible way.

In one aspect, the invention features a method of selecting items from an inventory for stocking a display in an enterprise. A request is received over a network from a user device to stock a display in the enterprise with items. A type of the display is ascertained. Inventory is analyzed to determine one or more types of items that are available in the inventory and suitable, based on one or more selection criteria, for stocking the type of the display. A response to the request is sent to the user device identifying, based on the analysis of the inventory, each type of item determined to be available in the inventory and suitable for stocking the display.

In another aspect, the invention features a server system comprising memory storing a server application program for recommending items available in inventory suitable for stocking displays in an enterprise, a network interface receiving, over a network from a client device, a request to stock a display, and a processor executing the server application program in response to the request. The server application program, when executed by the processor, analyzes the inventory to determine one or more types of items that are available in the inventory and suitable, based on one or more selection criteria, for stocking the type of the display. In addition, the server application program, when executed by the processor, sends, through the network interface, a response to the request to the user device identifying, based on the analysis of the inventory, each type of item determined to be available in the inventory and suitable for stocking the display.

In still another aspect, the invention features a computer program product for selecting items from inventory for stocking a display in an enterprise. The computer program product comprises a computer readable storage medium having computer readable program code embodied therewith. The computer readable program code comprises: computer readable program code configured, when executed by a processor, to receive, over a network, a request from a user device to stock a display in an enterprise with items; computer readable program code configured, when executed by a processor, to ascertain a type of the display; computer readable program code configured, when executed by a processor, to analyze inventory to determine one or more types of items that are available in the inventory and suitable, based on one or more selection criteria, for stocking the type of the display; and computer readable program code configured, when executed by a processor, to send a response to the request to the user device identifying, based on the analysis of the inventory, each type of item determined to be available in the inventory and suitable for stocking the display.

For some embodiments of these aspects, the request includes a combination of the type of display and zero, one, or more of the one or more selection criteria. In some embodiments, the one or more selection criteria require each type of item to be available in inventory in sufficient quantity to fill a target percentage of the display in order for that type of item to be considered suitable for stocking the display. To determine, for each type of item in inventory, whether that type of item is available in sufficient quantity to fill the target percentage of the display, some embodiments ascertain a cubic volume for the type of the display, determine a quantity of items available in inventory for that type of item, compute an aggregate cubic volume for that type of item based on the quantity of items available in inventory for that type of item, and determine whether the aggregate cubic volume for that type of item can fill the target percentage of the cubic volume of the display. The target percentage can be 100 percent or a fraction of the cubic volume of the display.

In some embodiments, the one or more selection criteria require a given type of items to be associated with a particular department of the enterprise in order for that type of items to be suitable for stocking the display. For other embodiments, the one or more selection criteria require a given type of items to be associated with a particular category of products in order for that type of items to be suitable for stocking the display. For still other embodiments, the one or more selection criteria require a given type of items to have not been displayed for a certain period, come from a particular supplier, be a specific brand, be preselected for the display's location, or be associated with a sales advantage, in order for that type of items to be suitable for stocking the display.

In one embodiment, the analysis of the inventory includes determining a feature score for each type of items in inventory. The one or more selection criteria can require the feature score of a given type of items to meet a threshold value in order for that type of items to be suitable for stocking the display. The response sent to the user device can include the feature score for each type of items determined suitable for stocking the display.

The feature score for a given type of items can be a function of the cubic volume of the display and an aggregate cubic volume associated with that type of items, of whether that type of items is involved in a pricing event, of a gross margin associated with that type of items, of quantity on-hand, of any associated pricing events, of estimated sales lift, of estimated profit lift, or any combination thereof.

### BRIEF DESCRIPTION OF THE DRAWINGS

The advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of an enterprise including a consumer area containing displays, an inventory area, and client and server computing systems.

FIG. 2A is a photograph of the front of an example end cap display with multiple shelves stocked with the same types of items.

FIG. 2B is a photograph of the front of an example end cap display with multiple shelves stocked with similar types of items.

FIG. 2C is a photograph of the front of an example display with multiple shelves stocked with dissimilar types of items.

FIG. 3 is a flow diagram of an embodiment of a process for stocking a display.

FIG. 4A is a flow diagram of an embodiment of a process by which a server application computes an aggregate cubic volume for items of a given type that are available in inventory.

FIG. 4B is a flow diagram of another embodiment of a process by which a server application determines which types of items are available in sufficient number and suitable for stocking a display based on the dimensions of the items.

FIG. 5 is a flow diagram of an embodiment of a client/server process for determining which types of items are suitable candidates for stocking a display.

FIG. 6 is a flow diagram of an embodiment of a process for analyzing types of items available in inventory, using feature score computations, to determine whether such items are suitable candidates for stocking a display.

FIG. 7 is a screen shot of an embodiment of a user interface window presented on a client device and used to request to find items in inventory suitable for stocking a display.

FIG. 8 is a screen shot of the embodiment of the user interface window in FIG. 7, with a department-selection pull-down menu opened to enable the user to choose a department from a list of different departments in the enterprise.

FIG. 9 is a screen shot of the embodiment of the user interface window in FIG. 7, with a feature-type selection pull-down menu opened to enable the user to choose the type of display to be stocked.

FIG. 10 is a screen shot of the embodiment of the user interface window in FIG. 7, with a sort-selection pull-down menu opened to enable the user to choose a sorting criterion by which to list or display recommended types of items within the window.

FIG. 11 is a screen shot of an embodiment of results returned in response to a request to find items suitable for stocking a display.

FIG. 12 is an example embodiment of a screen shot that appears on the client user interface when the user selects one of the items presented in the screen shot of FIG. 11.

FIG. 13 is a diagram of another embodiment of a data structure used to convey inventory and sales floor location information for an item selected by the user.

FIG. 14 is a diagram of an optional data structure used to convey new display location for an item selected by the user.

FIG. 15 is a diagram of an optional data structure used to convey total quantity on hand and quantity unavailable for an item selected by the user.

### DETAILED DESCRIPTION

Enterprises implementing the principles described herein can automatically identify items with sufficient inventory on-hand to fill a certain percentage of a selling feature space. When a merchant needs to stock a display (also referred to as a feature), the merchant can electronically submit a request for item recommendations through a computing device, for example, a mobile smart phone, programmed with an application program configured to submit such requests. In response to this request, a server system analyzes the inventory in search of types of items with sufficient quantity on hand to stock the display and, optionally, that satisfy other selection criteria. This automated identification of suitable items entails automatic calculation, scoring, and presentation to the merchant of various attribute values for the different types of items in inventory. The scoring and attribute information can help the merchant decide which available items are most appropriate to feature on the sales floor. Accordingly, this automated assessment of items in inventory can save time, increase productivity, and thereby increase sales and profits in ways that manual item-selection processes cannot.

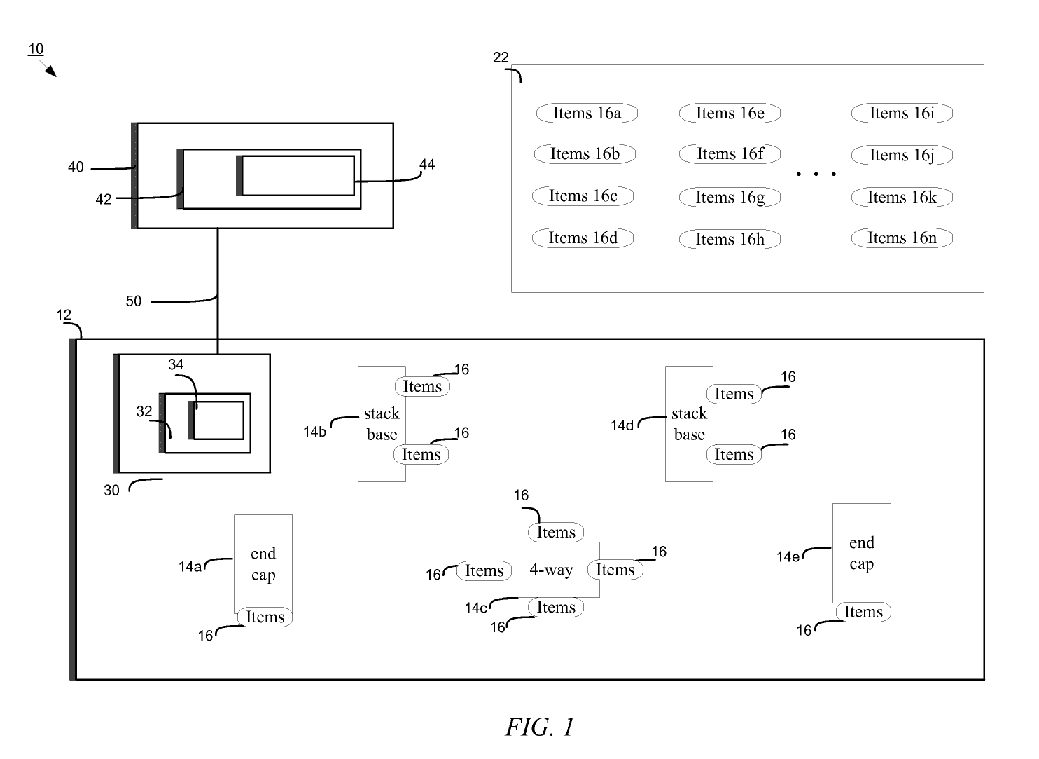

FIG. 1 shows an embodiment of an enterprise 10 including a consumer area 12 and an inventory area 22 typically located separately from the consumer area 12 and, possibly, at a different geographical location (e.g., a distribution center, warehouse, or home office). The enterprise 10 may be, for example, a consumer store, such as a department store or a grocery store, a private enterprise, a charity enterprise, or any enterprise where inventory stocking of items and displaying of items from inventory occurs. The consumer area 12 includes various displays 14a, 14b, 14c, 14d, 14e, (generally referred to as displays or features 14). As examples, the displays 14a and 14e are end cap displays, displays 14b and 14d are stack base displays, and display 14c is a 4-way display. An end cap display is a feature disposed at the end of an aisle, with shelves 18 predominantly facing one direction. A stack base display is a feature with a support surface or shelf upon which products (e.g., cases of soft drinks) may be placed, often in a stack. A 4-way display is a feature with shelves facing four different directions. It is to be understood, the principles described herein apply to many other types of displays than those described. For end caps and 4-way displays, one or more shelves are used to hold products for display.

Each display 14 preferably showcases a plurality of items 16. Each item 16 is a product with a unique stock-keeping unit (SKU) code. Without limitation, an item 16 can be an individual product (e.g., a bottle of shampoo) or a package or unit containing multiple products (e.g., a case of soft drinks). As illustrative examples, the end cap displays 14a, 14e showcase items 16 in a single direction, the stack base displays 14b, 14d showcase stacks of items 16, and the 4-way display 14c showcases items 16 in four directions.

The inventory area 22 of the enterprise 10 stores the various items 16a . . . 16n that may be stocked on any one or more of the displays 14.

The enterprise 10 further includes a client device 30 shown, for example, located in the consumer area 12. Example embodiments of the client device 30 include, but are not limited to, smart phones (e.g., the Apple iPhone™, RIM Blackberry™, Samsung Galaxy™ phones, and Google Android™ phones), tablets (e.g., the Apple iPad™), personal computers, and kiosks. The client device 30 includes a client application 32 configured, when executed by a processor, to produce a user interface 34.

The enterprise 10 also includes a server 40. The server 40 has a server application 42 and a recommendation engine 44. The server 40, server application 42, and recommendation engine 44 are shown as part of a single computing system of the enterprise 10, though it will be understood by those skilled in the art that the functions of the server 40, server application 42, and recommendation engine 44 can be distributed across the various computing systems of the enterprise 10 and beyond it. The server 40 is in communication with the client device 30 over a network 50 (represented here as a simple communication link). The network 50 can be, for example, a local area network or a wide-area network such as the Internet or World Wide Web, or a cellular network connection. The client device 30 can connect to the network 50 (and thus communicate with the server 40) through one of a variety of connections, such as standard telephone lines, digital subscriber line (DSL), asynchronous DSL, LAN or WAN links (e.g., T1, T3), broadband connections (Frame Relay, ATM), and wireless connections (e.g., 802.11(a), 802.11(b), 802.11(g), 802.11(n)).

In brief overview, a merchant, for example, an employee involved in stocking or restocking displays 14, uses the client device 30 running the client application 32 and provides certain information to the client application 32 through the user interface 34. Such information relates generally to the display 14 to be stocked and to other criteria to be used to select items. In response to the user-supplied information, the client application 32 communicates with the server application 42 over the network 50. The recommendation engine 44 of the server application 42 produces one or more recommendations for stocking the display 14 based, in general, on the user-supplied information, on other sources of information, and on the types of items 16 available in inventory 22. The server application 42 sends each recommendation to the client application 32, which displays the results on the client device 30 through the user interface 34. The results displayed can include the requested recommendations and other relevant information.

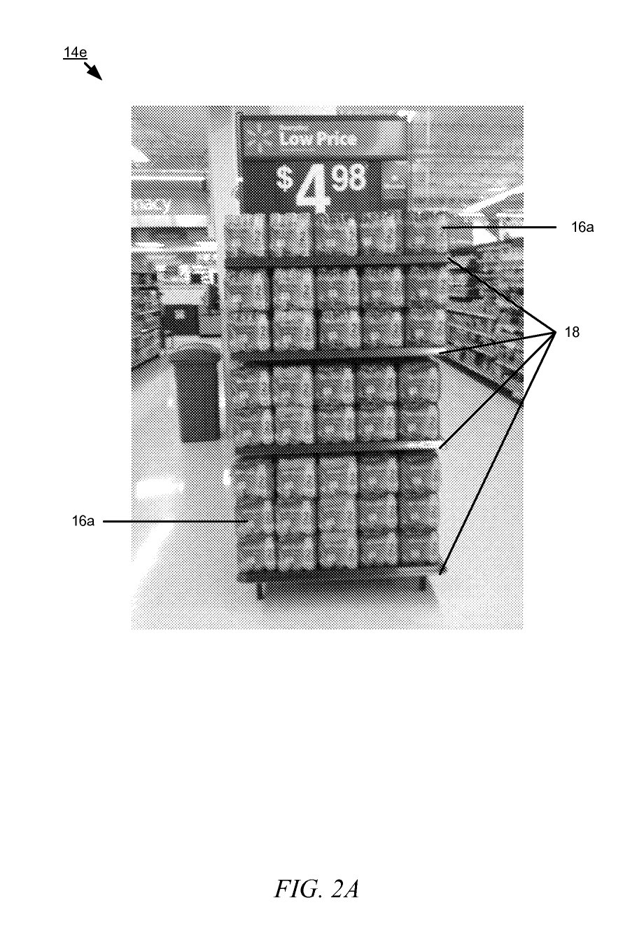

FIG. 2A, FIG. 2B, and FIG. 2C are photographs of example displays 14 stocked with different items 16. FIG. 2A shows an end cap display 14e with multiple shelves 18 stocked with the same type of items (i.e., with the same SKU) 16a, for example, drinks of the same flavor. FIG. 2B shows a mixed end cap display 14e with shelves 18 stocked with similar types of items (i.e., with different SKUs) 16b, 16c, for example, hand lotion bottles of the same brand, size, and price, but containing hand lotions of different fragrances. FIG. 2C shows a display 14 with shelves 18 stocked with a plurality of dissimilar items (i.e., with different SKUs) 16d, 16e, for example, cans 16d and boxes 16e of food that may have different brands, sizes, and price.

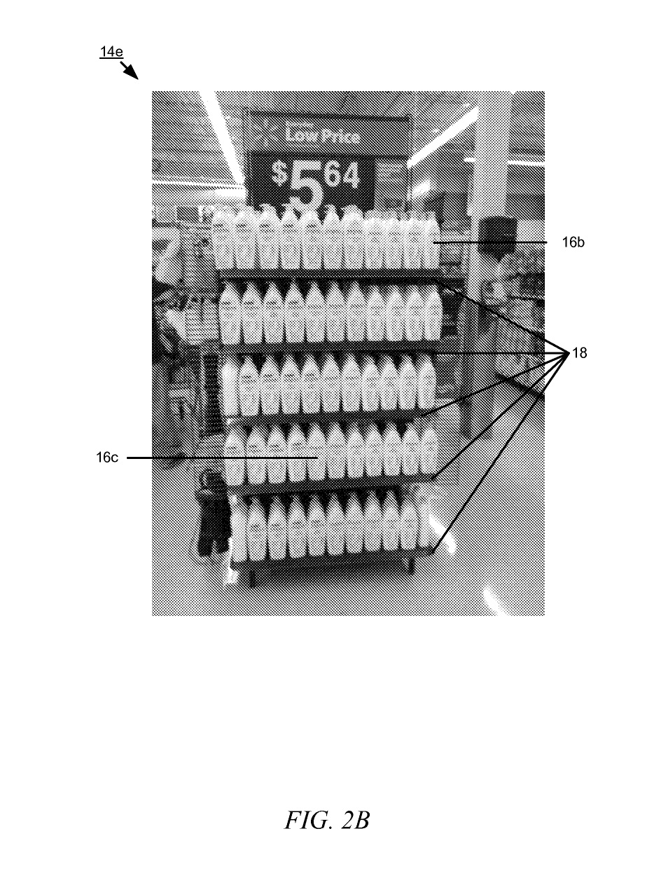

FIG. 3 is a flow diagram of an embodiment of a process 60 for stocking a display 14. In brief, when a display 14 in the enterprise 10 needs stocking or restocking, the server 40, in response to a request from the client device 30, analyzes the inventory 22 of different items 16a, 16b, . . . , 16n, to find items with sufficient supply on hand (i.e., available) to stock the display 14 in accordance with certain criteria, such as the type of the display 14, the available supply of each given item 16, the desired appearance of the stocked display (e.g., all one type of item, mixed similar types of items, mixed dissimilar types of items), and, optionally, other criteria. For instance, when stocking the display 14, a preferred objective is to make the feature 14 look somewhat full by having enough items disposed along the face of each shelf 18. In general, empty or partially empty shelves can make product appear picked through, which can discourage sales. Accordingly, the merchant desires to stock items along the leading edge of a shelf, occasionally with close spacing between items. Because the shelves of the display 14 may not be intended for storage, the server 40 does not need to consider filling the entire shelf with items, for instance, whereas the width (or facing) of a shelf after stocking will appear full (after stocking), the entire depth of the shelf may not be fully stocked with items.

When seeking to stock a display 14, a user of the client device 30 runs (step 62) the client application 32. The client application 32 sends (step 64) a request to the server 40 for recommendations for stocking the display 14. In response to the request, the server 40 ascertains (step 66) the type of the display 14 to be stocked. The server 40 analyzes (step 68) the inventory 22, in accordance with the type of the display 14 and, optionally, one or more other selection criteria, to determine one or more types of items 16 available in sufficient supply and suitable for stocking the display 14. For making this determination, the server 40 has access to information from various different business systems in the enterprise 10. These business systems depend on the type of enterprise 10. The business systems contain information about inventory, distributors and distribution, consumer displays, and the like. The server 40 can determine the suitable items based on information obtained from these business systems. After performing the analysis, the server 40 sends (step 70) a reply to the client device 30 identifying one or more types of items that are candidates for stocking the display 14.

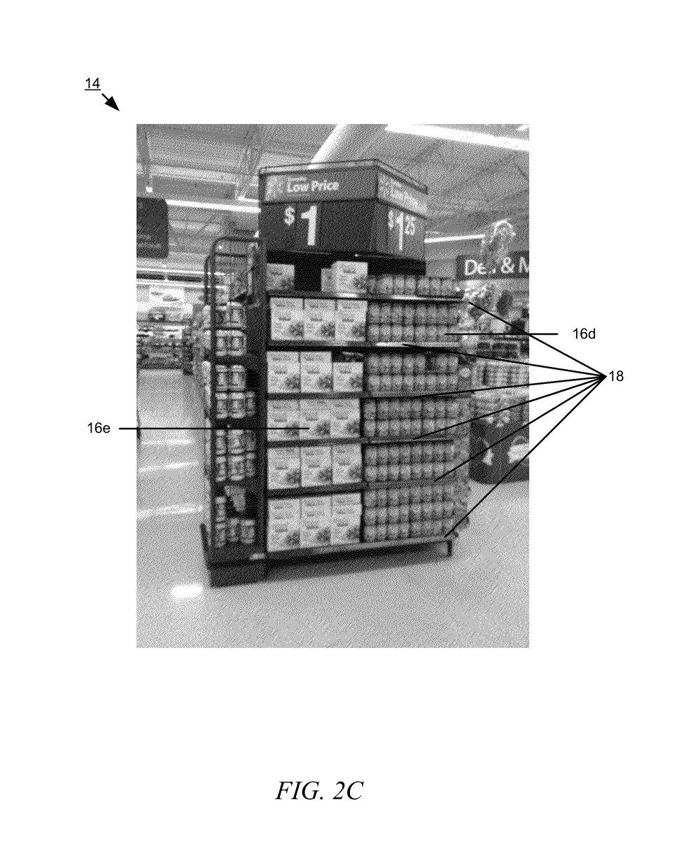

FIG. 4A shows an embodiment of a process 80 performed by the server 40 when analyzing inventory 22 to determine which types of items are available in sufficient number and suitable for stocking a display. For each type of item 16 analyzed, the server 40 acquires (step 82) the volume of an individual item 16 of that type (e.g., from a business system database), and determines (step 84) the quantity of such items 16 available in inventory 22 (e.g., from a business system database). The server 40 multiplies (step 86) the volume of the single item 16 by the available quantity of the item 16 to produce an aggregate cubic volume on-hand for that type of item. Having an aggregate cubic volume for a type of item on hand in inventory sufficient to fill a specified percentage of a display 14 is one selection criterion used to determine whether that type of item is suitable for stocking the display 14. For example, the aggregate cubic volume for a given type of item can be too small for a particular display, leaving too much empty space along the facing of one or more shelves of the display. However, if the specified percentage is one-half of a display, that same aggregate cubic volume of that type of item may be sufficient. For example, one or more other types of item can be displayed with that type of item. Alternatively, for example, the entire depth of the display may not need filling.

There are other methods for properly stocking a display. FIG. 4B shows one such example of another embodiment of a process 90 performed by the server 40 when analyzing inventory 22 to determine which types of items are available in sufficient number and suitable for stocking a display. For each type of item 16 analyzed, the server 40 acquires (step 92) the dimensions of an individual item 16 of that type (e.g., from a business system database). The server 40 ascertains (step 94) whether the dimensions of the individual item 16 exceed the capacity of the display 14 or shelf 18. Items whose dimensions exceed that of the type of display are excluded from recommendation. The server 40 also determines (step 96) the quantity of items 16 (if, based on the dimensions, deemed suitable) available in inventory 22 (e.g., from a business system database). In addition, the server 40 determines (step 98) the number of facings that will fit on the display 14 and the number of items that will fit in each facing.

Accordingly, when the actual dimensions of an item are known (i.e., width, height, depth), the server 40 can determine how many items are needed to fill all the shelf facings, how many shelves are needed, and the minimum number of items needed based on how many items are needed per facing. To illustrate with an example, if an item is 4″ in width, 12″ in height, 4″ in depth, and a shelf is 48″ wide, 12″ deep, and 3″ high, each shelf can support 12 (48″/4″) facings. If the display 14 is 84″ in height, it can have 5 shelves 84″/(12″+3″ for shelf thickness). Accordingly, 60 items (12*5) are needed to fill all 5 shelves one item deep. If, for example, there is a minimum requirement to be 3 items deep, then 180 items (60*3) are needed to meet the minimum quantity. Such a method can be more precise than basing a filling decision on a target percentage of cubic volume. Thus, this method can inform the user about the number and types of shelves needed, the number of cases of items needed, etc. Further, this method can avoid recommending items that are too big to fit on a particular display (e.g., a 24″ inch deep ride-on toy for a 12″ deep display).

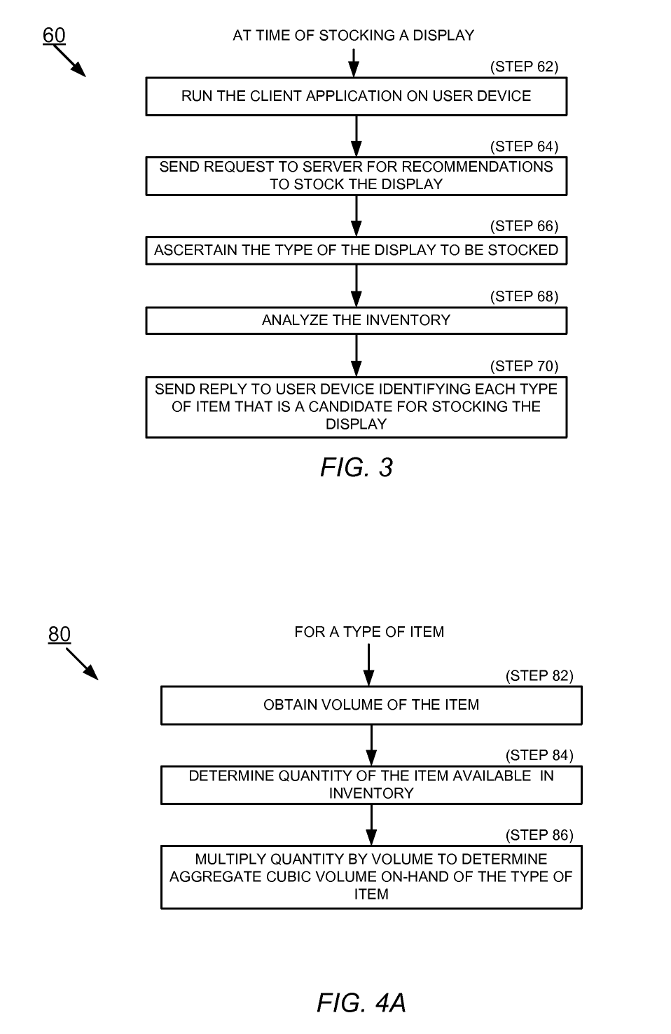

FIG. 5 shows an embodiment of a process 100 for stocking a display 14 having a certain size, in terms of cubic volume. When a user needs to stock a display 14, the user runs (step 102) the client application 32 on the client device 30 and provides certain information related to the task, for example, the type of display 14 to be stocked. Optionally, the user can supply other information that serves as one or more selection criteria used to filter items when analyzing inventory 22 suitable for stocking the display 14. The client application 32 sends (step 104) a request for finding suitable items, the type of display, and selection criteria, if any, to the server 40 in one or more communications over the network 50. For example, the request from the client device 30 can include the type of display, or a separate subsequent communication can identify the type of display.

The server application 42 running on the server 40 receives (step 106) the request and user-supplied information, including the type of display and any other selection criteria. In response to the request, the server application 42 analyzes (step 108) the inventory 22 by checking each type of item 16 against the type of display. If the aggregate cubic volume (computed as described in FIG. 4) for a given type of item 16 is sufficient for the type of display, that type of item may become a candidate for stocking the display, provided that type of item 16 also satisfies other criterion, if any, submitted as part of the request. The inventory analysis can involve computing a feature score, described subsequently in more detail. After finding one or more candidate types of items suitable for stocking the display 14, the server application 42 sends (step 110) a response to the client application 32, identifying each candidate item type. The server application 42 can send this response after evaluating all types of items 16a, 16b, . . . , 16n available in inventory 22, or, for example, after identifying a threshold number of candidates that satisfy the volume and any other selection criterion.

The client application 32 receives (step 112) the response from the server 40 and displays (step 114) a representation of those types of items deemed suitable on the screen of the client device 30. The representation can include an image of each candidate item. Other methods for reporting the results can be used without departing from the principles described herein. For example, the results can be displayed on a printout report (i.e., paper).

The client application 32 can display (step 116), on the client device 30, an option to create a task in an external business system to stock the display with the selected item 16.

### Feature Score

In a small enterprise 10, for example, a retailer of a particular item 16, or a charity enterprise, it may be reasonable to stock or restock a display 14 based solely on the aggregate cubic volume or dimensions of each type of item 16 on hand. Other enterprises 10 may find it useful to identify types of items for stocking displays based on other selection criteria in addition to the aggregate cubic volume. In one embodiment, the inventory analysis involves computing a feature score for the different types of items 16a, 16b, . . . , 16n in inventory 22. In general, the formula for computing the feature score embodies the various selection criteria used to select types of items from inventory 22.

For example, an enterprise 10 selling a particular item 16 may want to ensure that the quantity of items 16 available in inventory for stocking a display 14 is sufficient to stock the display 14 in its entirety. A selection criterion can be that the inventory 22 needs to have a minimum quantity of a particular type of items 16 on hand in order for items of that type to be eligible for stocking the display 14. In addition, conceivably some of the in-stock inventory of that particular type of item may not be usable or available for stocking the display. For example, a side counter, where such items are sold when not featured, may require an allocation of some of the in-stock inventory. The enterprise 10 may not want this side counter to be empty simply to fill a display 14. Accordingly, this allocation is deducted from the quantity in inventory when determining whether the particular type of item qualifies for stocking the display. Additionally, some items in inventory may be in a non-saleable condition, such as an item in the claims system. Items in a claim system are those that are damaged, recalled, expired, etc. Preferably, such items are also deducted from the final tally of the quantity of items of a particular type considered available for stocking the display 14.

In one embodiment, the server 40 can report to the client device 30 that a sufficient quantity of items are available in inventory 14 to replace (i.e., to refill) the same or similar items taken or sold from the display 14 in a given period. This capability can reduce labor by avoiding needing to replace the display entirely with another type of item shortly after building the feature. Inventory of a type of item can be deemed sufficient if enough items are on hand to support a specific period of sales (e.g., a week) and to keep the display appearing appropriately populated at the end of that period.

In accordance with another example, a department store sells items such as food, health and beauty aids, toys, and clothes. The user of the client device 30 may find it useful to specify additional selection criterion, for example, limiting candidate items for stocking the display to those that come from the same department or from a particular sub-category of products (for example, tomatoes and peppers). Another selection criterion can be to choose, when more than one type of item has a sufficient quantity on hand, the type that has the greater available quantity. Alternatively, the type of item with the lesser quantity may be preferred because such items are an end-of-life or end-of-season product. In such an instance, the selection criterion can be to give preference to an end-of-life type of item in order to deplete its inventory. Still other selection criteria can be to give preference to a type of item that has been in inventory beyond a certain number of days or weeks, or has not been prominently displayed for a certain period, or to recommend types of items that will soon be out of season, because, once out of season, such items can become a liability, needing a price reduction in order to sell.

During an analysis of inventory, during which any combination of one or more selection criteria may be considered, more than one type of item can conceivably satisfy their conditions. To rank these candidates, the recommendation engine 44 of the server application 42, running on the server 40, produces a “feature score”, which takes into account these and possibly other selection criteria, weighing the selection criteria according to importance. Accordingly, formulas for computing feature scores for types of items can be configurable and vary, depending on what is deemed important in, for example, a particular market, country, or department of the enterprise 10. Within a given store or department, for example, an end user may use an array of tactics to meet business goals and objectives. Accordingly, the enterprise 10 can offer multiple different formulas from which to choose. These formulas may be pre-determined and may not be visible to the end user. Instead, the end user may see a label or name for each formula, and selects from among the available formulas.

In general, an example embodiment of a formula for computing a feature score is as follows:

Feature Score(i)=f(Quantity On-hand Score(i), Quantity On-Hand Factor(i), Pricing Event Score(i), Sales Lift Score(i), Sales Lift Factor(i), Profit Lift Score(i), Profit Lift Factor(i), Location-Item Type Score(i), Forecast Quality Score(i))

According to the formula, the feature score for type of item (i) is a function of several computed parameters: a Quantity On-hand Score, a Quantity On-Hand Factor, a Pricing Event Score, a Sales Lift Score, a Sales Lift Factor, a Profit Lift Score, a Profit Lift Factor, Location-Item Type Score, and Forecast Quality Score for that type of item (i). Other embodiments of feature score formulas can have fewer or more of the same or different parameters.

The Quantity On-hand Score parameter evaluates the quantity of a type of item available on a volume basis. Consider that “Feature Volume” corresponds to the volume of items needed to stock a given display (e.g., an end cap display, or whatever type of display the end user has selected). One example formula for computing the Quantity On-hand Score is:

Quantity On-Hand Score=Quantity On-hand Cubic Volume/Display Volume

In addition, the enterprise 10 can also extend this calculation to include values less than 1, for example, to run down merchandise or to feature two or more items. Another extension to this formula can be to reduce the Quantity On-hand Score by the side counter quantity, the claims quantity, the reserved-for-customer order quantity, and/or the “On display item” quantity, because such quantities may not be available to put on the display 14 that is being stocked.

The Pricing Event Score parameter accounts for “on sale” pricing mechanisms often employed by enterprises. Such pricing mechanisms, for example, “clearance”, “super savings”, affect the current pricing of an item. If a pricing mechanism currently affects a given type of item, the Pricing Event Score parameter factors in the pricing effect. One example formula for computing the Pricing Event Score is:

If an item is subject to a pricing effect, the Pricing Event Score=2; else, the Pricing Event Score=1.

The Sales Lift Score parameter represents the forecast for a sales increase per week as a result of featuring this type of item. One example formula for computing the Sales Lift Score is:

Sales Lift Score=Sales Lift Quantity*Unit Sell Price,

where Sales Lift Quantity=Average Sales Quantity*Lift Percentage,

Average Sales Quantity is estimated based on sales history of item or similar items, and

Lift Percentage represents change in sales when the item is featured (e.g., −0.5 indicates sales went down 50%, 1.0 means sales went up 100%).

The Profit Lift Score parameter represents the Sales Lift Score multiplied by the Item margin. This value represents the amount of gross margin the item should produce per week if featured.

In the example Feature Score formula, each of the Quantity On-hand Score, Sales Lift Score, and Profit Lift Score parameters have corresponding weighing factors used to weigh (i.e., multiply) each respective score. Specifically, the Quantity On-hand Score has a Quantity On-hand Factor, the Sales Lift Score has a corresponding Sales Lift Factor, and the Profit Lift Score has a corresponding Profit Lift Factor. Values assigned to these factors may be based on a variety of attributes including, but not limited to, country, market, department, and time of year. These weighing factors can make the recommendation engine 44 flexible and robust, by enabling its use in various client and server applications across many different types of enterprises.

More particularly, the Feature Score accounts for different enterprises 10 having different needs when stocking displays 14. Further, a single enterprise 10 has different display-stocking needs at different times. Factors in the feature score formulation can balance a feature score calculation accordingly.

The Quantity On-hand Score is computed for enterprises 10, wherein the volume of items 16 needed to stock a display 14 is important to the enterprise. Factors that affect the Quantity On-hand Score are, for example, those related to available inventory. The Quantity On-hand Score involves a calculation of the aggregate cubic volume for items of a given type. As the example formula for the Quantity On-hand Score illustrates, there needs to be more items in inventory than are required to stock the volume of the display 14. In some instances, the Quantity On-hand Score can account for more than Y days of inventory available so the suggested item does not deplete too soon. So, according to the example formula, the Quantity On-hand Score increases as the cubic volume of inventory for the type of items being evaluated exceeds the volume of the display 14. Values for the Quantity On-hand Score of less than 1 can serve as an indicator, for example, that there are fewer items than what is needed to fill the entire display, or to feature two or more items 16 on the display 14.

The Quantity On-hand factor can be used to weigh the importance of the Quantity On-hand Score. For instance, the Quantity On-hand Score may be more important in an enterprise such as a large department store than in a store that sells few items or a non-retail enterprise. On occasion, stocking a display 14 may not be needed at the time a feature score is calculated. The Quantity On-hand factor can be adjusted accordingly, heavily or lightly, to weigh the affect of the Quantity On-hand Score on the overall Feature Score. For example, in a single item retail store or a private enterprise 10, the Quantity On-hand Factor can be set equal to zero, because that item is needed for display irrespective of the quantity available. Another example involves planning to order items for a future date. The enterprise can score and rank all the types of items in the store to identify the “best” item to feature during an upcoming week, for example. This instance does not require any current quantity on-hand. Alternatively, in a store where the quantity available is important, the Quantity On-hand Factor can be set equal to one or greater.

The Quantity On-hand factor can also be used to adjust dynamically for certain conditions or situations, such as inventory seasonality of types of items and sales or pricing events. For instance, a user may determine that one type of item available in inventory is of a preferred product line or category, but may be of insufficient volume to stock an end cap or stack base display, and yet enjoys a significant sales lift when featured during the current season. Such conditions can warrant using a fractional equation for computing the Quantity On-hand Score (to stock less than all of the display) and using a value for the Quantity On-hand factor that weighs the Quantity On-hand Score heavily.

The Sales Lift Score parameter of the Feature Score relates to an increase or decrease in “sales” of the candidate items. Sales lift is calculated using data extrapolated from the sales lift of a different or similar type of items when similarly displayed in a similar market and period. If the sales lift percentage is 0%, the Sales Lift Score is equal to zero. In an alternative embodiment, the sales lift percentage may be a negative value to represent a loss of sales on a type of item 16. The Sales Lift Score can also be influenced by the sell price of an item, with greater values of the Sales Lift Score corresponding to higher sell prices. The Sales Lift factor can be used to weigh the influence of the Sales Lift Score on the overall Feature Score. The Sales Lift Score may increase or decrease based on, for example, the seasonality of items, volume sales of items, or sales price items.

The Profit Lift Score parameter of the Feature Score corresponds to the Sales Lift Score of an item type multiplied by the margin of that item type (more specifically, the weekly gross margin expected for the item per week if the item is displayed in a feature 14). This Profit Lift Score can operate to offset a price bias introduced by the Sales Lift factor.

The Profit Lift Factor can be used to weigh the influence of the Profit Lift Score on the overall Feature Score. The Profit Lift Factor may increase or decrease based on various factors. Sometimes items may be chosen for display as profit items; other times certain items may be chosen for display to draw interest towards other items, that is, those displayed items may not necessarily be profit items themselves. The value given to the Profit Lift Factor can vary based on varying business interests.

The Location-Item Type Score parameter of the Feature Score relates to the past sales lift performance of different categories of item types at a specific or similar location. This score gives insight for determining the sales performance of a category of items relative to another category of items for a given location. Advantageously, this comparison can help management determine the best locations for different categories of item types throughout an enterprise.

The Forecast Quality Score parameter of the Feature Score relates to the quality of the recommendation produced by the feature finder system. This score can facilitate a comparison between how a given item type actually performed when featured for a specific period at a specific display location within the enterprise (i.e., actual sales lift) and its forecasted performance determined at the time the given item type was originally put on that display. Advantageously, this comparison can help fine tune the feature finder system and provide guidance for adjusting merchandising tactics.

Promotional pricing can have its own element in the Feature Score formula because promotional pricing directly affects margin. Promotional pricing also affects sales lift, and can have an effect on the Sales Lift Score and Profit Lift Score.

Weight factors can overlap to affect the Feature Score. Consider, for example, that the current available inventory of a suggested type of item is less than Y days of inventory. Accordingly, this type of item can produce a low Quantity On-hand Score. Notwithstanding, because of seasonality and recent sales, this type of item can also produce a high Sales Lift Score. The combination of the low Quantity On-hand Score and high Sales Lift Score can thus produce a moderate overall Feature Score for the suggested type of item currently available in inventory.

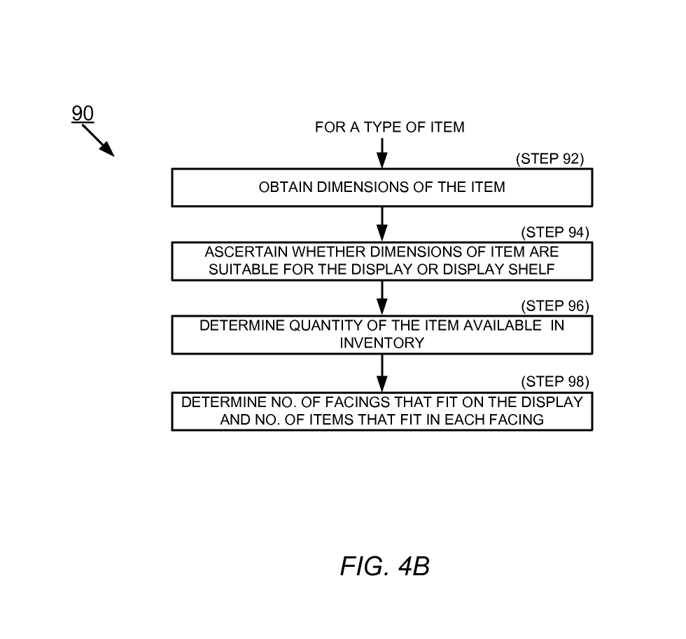

FIG. 6 shows an embodiment of a process 120 for analyzing types of items available in inventory 22 to determine which items can satisfy a need to stock a display 14. The recommendation engine 44 running on the server 40 can perform this process 120 in response to a request received from the client application 32 running on the client device 30. At step 122, the recommendation engine 44 chooses a type of item in inventory for analysis. The recommendation engine 44 computes (step 124) the aggregate cubic volume for all items available in inventory 22 for that item type. At step 126, the recommendation engine 44 computes a feature score for the type of item under analysis.

If no more types of items are to be analyzed, for example, because the recommendation engine 44 has completed analysis of all types of items in inventory or has reached a sufficient number of item types to recommend, the recommendation engine 44 can issue (step 128) a recommendation based on the feature score. The recommendation can be to stock the display 14 with one type of item or with a mixture of multiple types of items. For instance, if the aggregate cubic volume of a given type of item is insufficient for the full cubic volume of the display 14, the type of item can still be considered for stocking a fraction or subsection of the display 14. If more than one type of item satisfies the various selection criteria embodied by the feature score, the recommendation engine 44 can provide a ranking of those item types based on their feature scores.

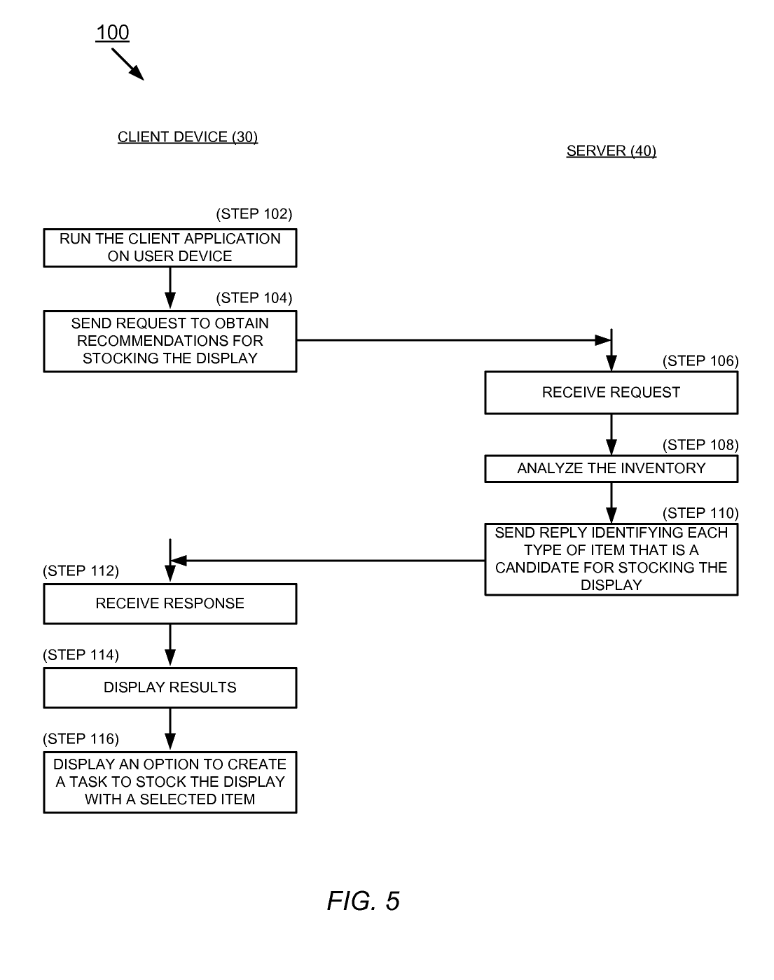

FIGS. 7-10 shows screen shots of an embodiment of a user interface 34 presented on a client device 30 and used to request a recommendation of items for stocking a display. The screen shot includes an interactive window 150 with various pull-down menus 152. The menus 152 include, for example, a department-selection menu 154, a feature-type selection menu 156, and a sort-type selection menu 158. These menus 152 enable the user to supply certain information used to perform the inventory analysis. The types of information that can be submitted through these menus 152 are for illustration purposes only; other embodiments of the window 150 can have different, fewer, or more menus 152 than what is shown and described, by which the user can submit the same information, other types of different information, or combinations thereof. The window 150 also includes an activation button 160 used to send the request for recommendations based on the selections indicated by the various pull-down menus 152.

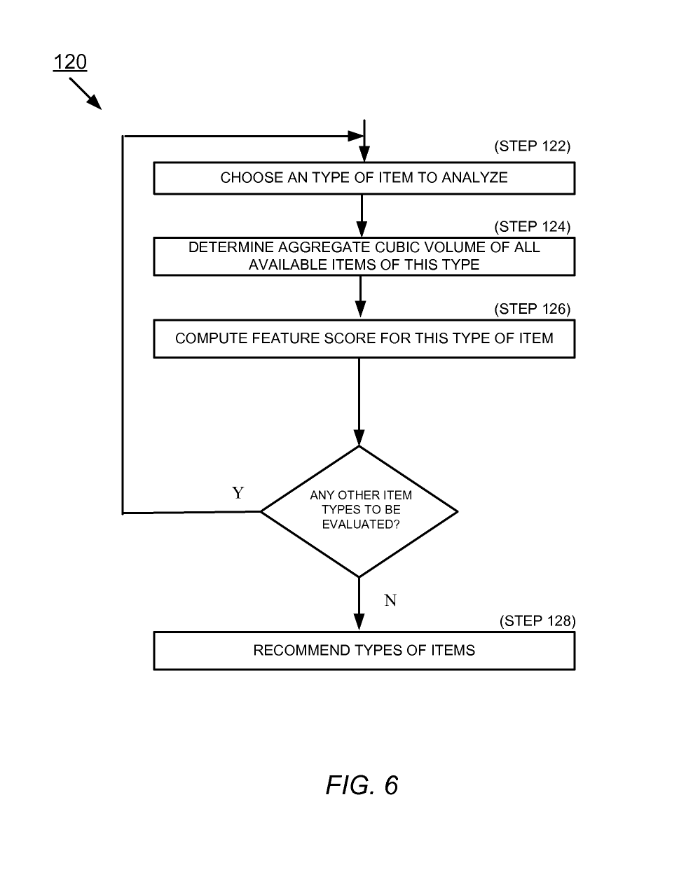

FIG. 8 shows the window 150 with the department-selection pull-down menu 154 opened to enable the user to choose a department from a list of different departments in the enterprise 10. In this example, the user highlights the Toys department. Such a selection can operate to cause the analysis of inventory 22 to limit or give preference to items in the Toys department.

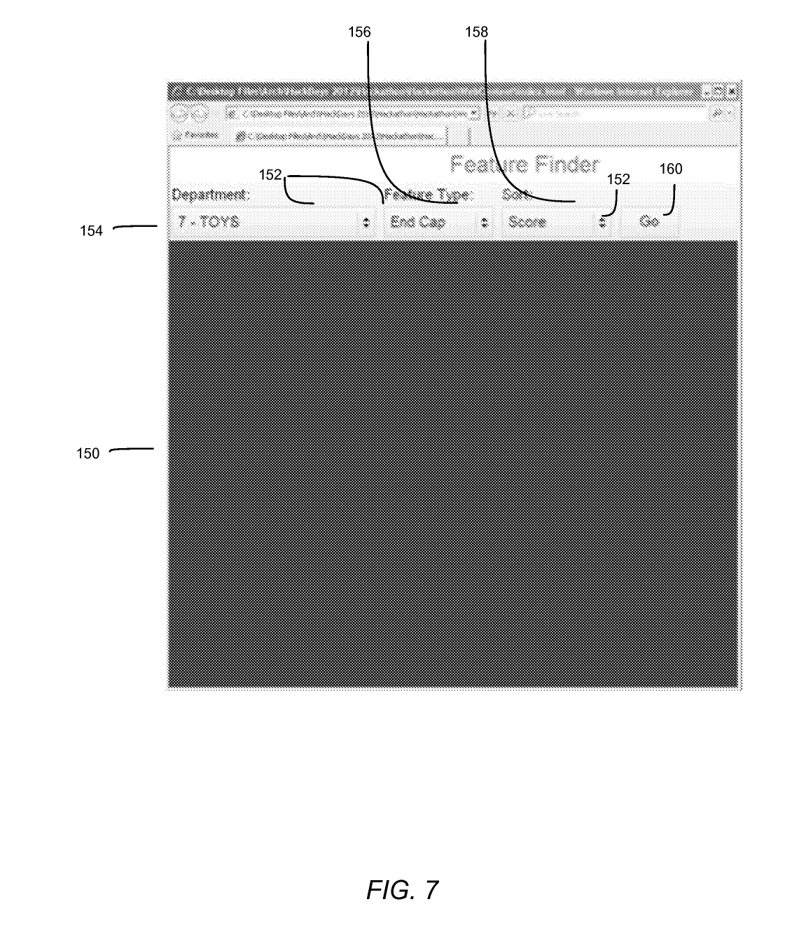

FIG. 9 shows the window 150 with the feature-type selection pull-down menu 156 opened to enable the user to choose the type of display 14 that is going to be stocked. In this example, the feature-type selection pull-down menu 156 identifies three types of displays: an end cap display, a stock base display, and a 4-way display. In this example, the user highlights the end cap type of display. Such a selection informs the server application 42 of the type of display to be stocked so that the server application 42 can determine the cubic volume or number of items to be stocked.

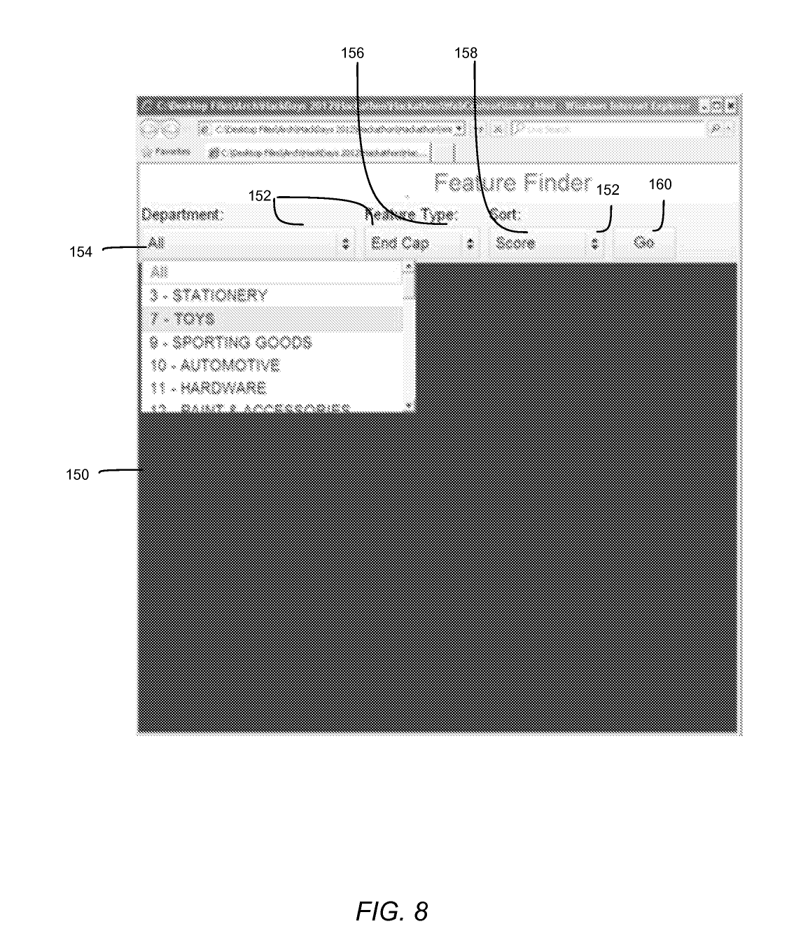

FIG. 10 shows the window 150 with the sort-selection pull-down menu 158 opened to enable the user to choose the sorting criterion by which to list or display recommended types of items within the window 150. In this example, the sort-selection pull-down menu 158 enables sorting according to the Name of the recommended items, Quantity On-hand for the recommended items, Price (from highest to lowest), and Price (from lowest to highest). In this example, the user chooses to sort by item Name. The user can perform a sort selection before submitting the request for recommendation or after the list or recommendations returns from the server 40.

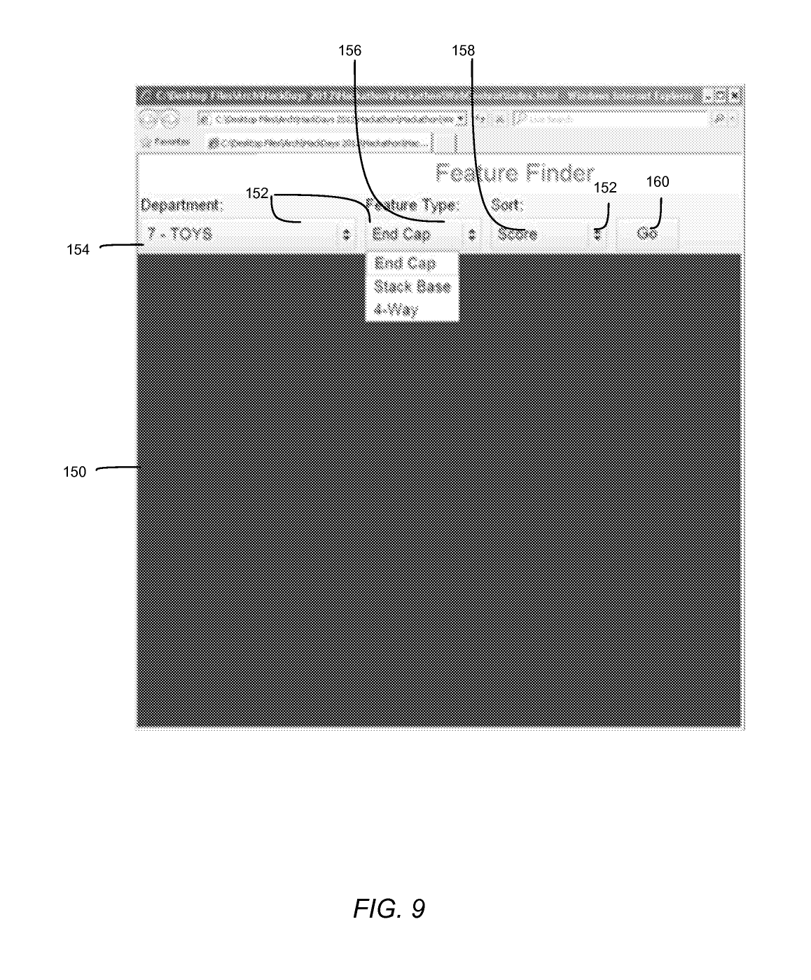

FIG. 11 shows an example of a screen shot displaying items returned from the server 40 in response to a request for item recommendations submitted by a user of the client device 30. In this example, the selection criteria submitted as part of the request is to recommend items for a stack base display, and to limit the inventory analysis to the Toys department. Results, portrayed as images 170 of the recommended items, are sorted based on feature score. In this example, accompanying each image 170 representing a recommended item are a description 172 and a star rating 174. The star rating 174 is a symbolic representation of the feature score for the item. Promotional pricing event indicators can also appear in the results, as illustrated by the word “Clearance” above the “Fixie Bike” item displayed in FIG. 11. Other promotional events can be signified by other names, such as “Sale” and “Special”. Examples of other information that can accompany each item include, but are not limited to, pricing information 176 and the quantity on hand 178 for that item. The user can select (e.g., with a mouse click) any of the displayed item images 170 for a detail view.

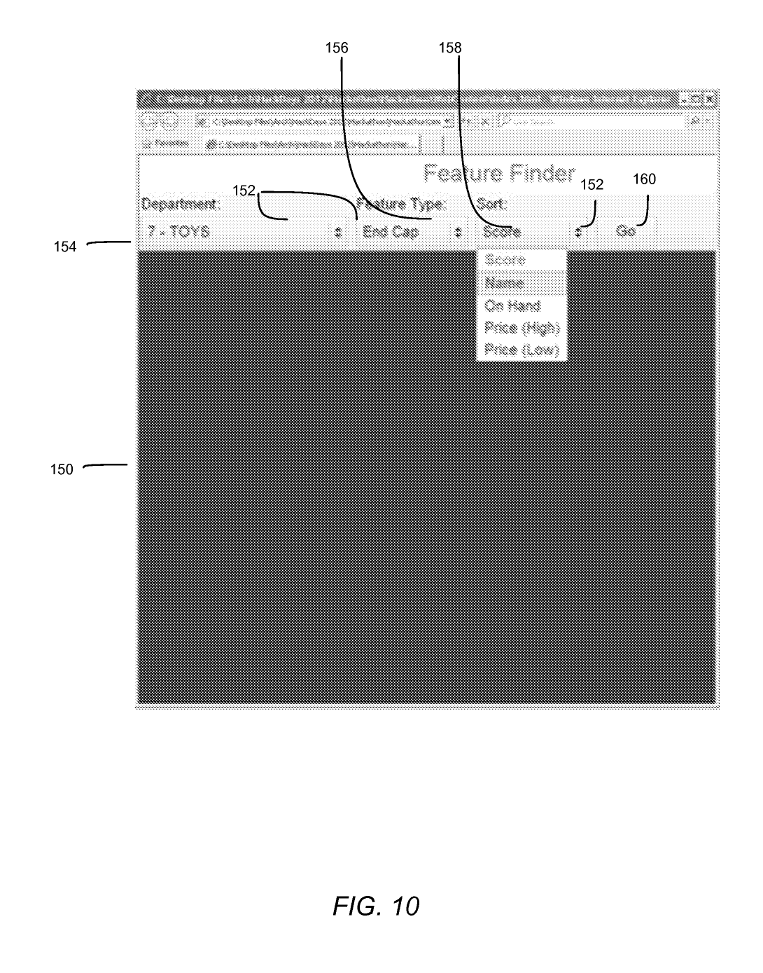

FIG. 12 shows an example of a screen shot displaying a detail view 180 of an image 170-1 in FIG. 11 selected by the user for a detailed review. A table 200 appears below or adjacent the image 170-1. A top row 202 of the table 200 contains an identifier 202a and name 202b of the item 170-1. The other rows in the table 200 include an identifier and one or more corresponding values. For instance, row 204 includes price 204a and a corresponding price value 204b. Other entries shown herein include, but are not limited to: Score 206, UPC 208, Item Number 210, On Hand 212, Bin Locations 214, Sales Lift 216, Sales Quantity Forecast 218, Profit Forecast 220, Fill Ratio 222, Sales margin 224, Cost 226, and Retail Forecast 228.

Price 204, indexed as price 204a, is the price of the item displayed, as shown at 204b. Score 206a corresponds to the visual rating of the feature score for the item, shown at 206b. UPC 208a is the universal product code for the item, as is known in the art. The corresponding UPC code is shown at 208b. The item number 210a can be used by the enterprise as its personal identifier for the item in addition to the UPC 208a. The item number is shown at 210b. On Hand 212a is the quantity of items available in inventory to satisfy the need for stocking the display. The corresponding value of the quantity On Hand is shown at 212b.

The cost 224a of the item is displayed as a currency value at 224b, and the Gross Margin 226a is also displayed as a percentage at 226b.

Sales lift 216 is presented as a table, with rows of Units Sold 228, Sales 230 and Profit 232 and columns of Basis Sales 216a, Featured Sales 216b, Lift Qty 216c and Lift % 216d. Because Lift % is the same for each row, it is displayed as a merged cell 216e.

In one embodiment, Units Sold for Basis Sales 228c is calculated from average historical sales for this item when not featured on display and is presented as a rounded value; Units Sold for Featured Sales 228d is computed from multiplying an embodiment-specific sales lift metric by the Units Sold for Basis Sales 228c. The Units Sold Lift Quantity 228e is calculated as the difference between 228d and 228c. In one embodiment, Sales 230 are calculated by multiplying each of the Units Sold 228 columns by the retail price 204b and displayed in corresponding columns in row 230b. Similarly, in one embodiment, Profit 232 is calculated by multiplying each of the Units Sold 228 columns by the difference of the retail price 204b and cost 224b, and displayed in corresponding columns in row 232b.

The fill ratio 222a is the percentage of the display volume that would be filled based on the available inventory of the item. The fill ratio value shown in 222b is calculated from the Quantity On-Hand Score. In an enterprise where inventory consists of many types of items potentially suitable for stocking a display, this value is highlighted or color-coded. For example, if available inventory of the item is less than 100%, it can be color coded red as a low inventory notice. If the available inventory of the item is more than 150%, it can be color coded green as a notice of sufficient inventory. Any inventory amount in between can be color coded orange.

For the Bin Locations 214a entry, the value 214b consists of an array 214c. The columns 214d of the array 214c contain information, examples of which include, but are not limited to, “aisle”, “rack”, “slot”, and “quantity”. Each column 214d of the array 214c provides a portion of the information about the locations in inventory 22 for the type of item displayed. For example, row 214e indicates that aisle 9, rack 1, slot 3 contains two of the selected type of item. The bin locations array 214c can be configured to provide less or more of the same or different information than shown in the example of FIG. 12.

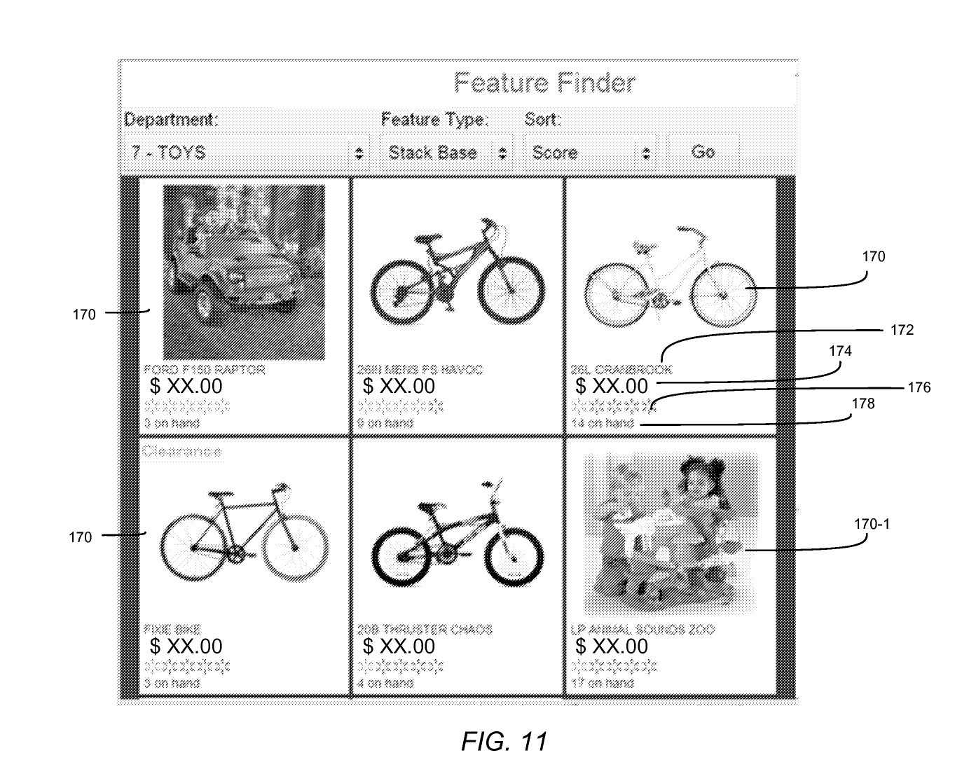

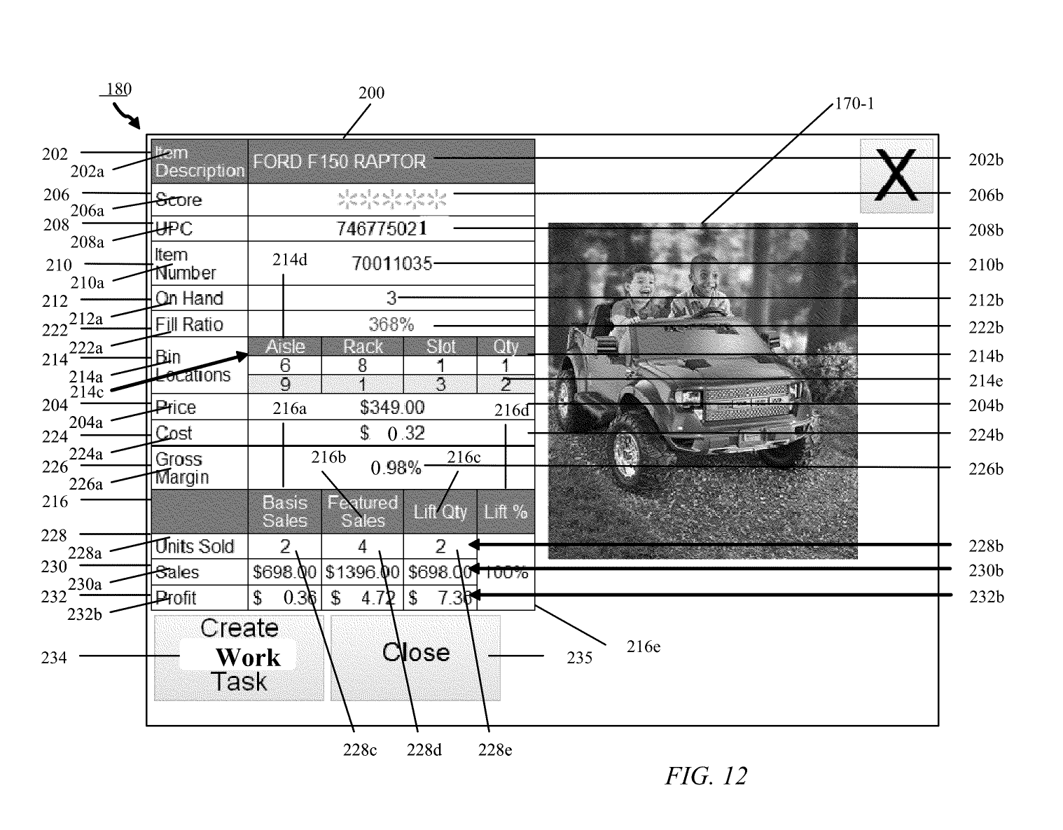

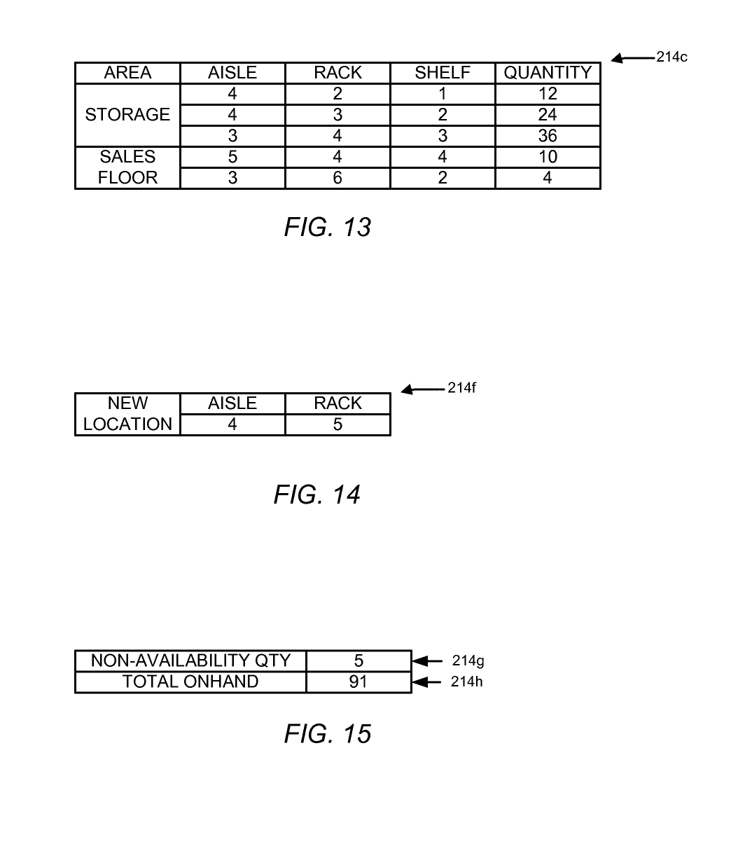

For example, FIG. 13 shows a modified version of the bin location array 214c of FIG. 12. The modified bin location array 214c includes the inventory (i.e., “back room” or storage) location(s) for the selected items and information about the “sales floor” location(s) where the selected item is presently on display within the enterprise. Similar to the storage location information, the sales floor location information includes aisle, rack, and shelf information. The quantity of the selected item at a given storage inventory location is an overstock quantity that is available for use in stocking a display (feature), whereas the quantity of the selected item at a given sales floor location is an estimation (this quantity is optional). The bin location array 214c can also be with a new location table 214f, an example of which is shown in FIG. 14. The new location table 214f identifies the location (specifically, aisle and rack) within the enterprise of the display being stocked. Other optional modifications to the bin location array 214c include, but are not limited to, adding an entry 214g for the quantity of items that are unavailable for stocking a display and an entry 214h for the total number of items on hand (as shown in FIG. 15).

The “aisle” and “rack” information can be provided by the client application 32 to the server application 42 when executed. For example, in a department store setting, in addition to the type of display, the user of the client application 32 can input a particular name or identifier of the display that is being stocked. The name or identifier is then used to identify the location in the store of the display. Alternately, if the user is using a mobile device, the user can scan the display or an item on the display. The information scanned is then used to identify the location of the item or display based on where the user is located. This information is useful for Sales Lift Score and Profit Lift Score calculations, as the location of the display in the store can impact the sales of products displayed thereon. By analyzing the effect on sales lift in one feature location as compared to other locations, an enterprise can strategically place feature items based of the business objectives at the time. Alternatively, the “aisle” and “rack” information can be provided by the server application 42 itself. The server application 42 can obtain this information from aforementioned business information servers or systems in the enterprise 10.

Although described in connection with recommending items for stocking a display, use of Feature Score computations can extend to other types of applications. For example, Feature Scores are generally useful for identifying items in inventory to feature in the future, to move from inventory to display, and to restock inventory. Management can determine beforehand what items should be featured, then order the items to arrive the week the feature is to be displayed. This Feature Score can be used to identify or review items for that effort.

Furthermore, the information examined by the Feature Score can be used in other ways. For example, since the recommendation engine 44 gathers the type of display and identifies particular items in inventory for stocking the display, the recommendation engine 44 can gather also the location of the display, or the location of the user of the client device, to ascertain the location of what could be a newly featured item. This information can then be integrated into an application for use by customers for such purposes as locating items in the store, or being notified of featured items. Such information can also be used to instruct the stocking personnel where to build the feature or where to replenish items for the feature. In addition, the information can inform the feature management system that the old item in that location is no longer on the feature (when it is replaced with a new item).

The location of an item to be displayed is stored in one of several ways as described above, and, in accordance with one embodiment, stored in the modified bin location array 214c described in FIG. 13. This information can be made available to consumers within the enterprise as part of a consumer application. For example, when a consumer enters the store, the consumer may be looking for a particular item. The consumer can invoke a client application, for example, on the consumer's mobile device such as a mobile smart phone, or on an in-store kiosk, that invokes an enterprise application. The client application notifies the consumer as to the location inside the store of the item the consumer seeks, for example, the aisle in which the display resides, and the location on the display. Furthermore, optionally, the application notifies the consumer of the location in the store of items that are on sale or otherwise under promotion. The client application may also give directions to the appropriate display.

A user interface control element 234 is available for the user to create a task in an external business system to execute the stocking of the display with the selected item. Information that can be delivered from this system 40 includes the item number 210b, the UPC 208b, the on hand quantity 212b, bin locations 214c and other items deemed of interest to the external system. A second user interface control element 235 is available for the user to close the details window 180 without creating such a task.

As will be appreciated by one skilled in the art, aspects of the present invention may be embodied as a system, method, and computer program product. Thus, aspects of the present invention may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, radio frequency (RF), etc. or any suitable combination thereof.

Computer program code for carrying out operations for aspects of the present invention may be written in any combination of one or more programming languages, including an object oriented programming language such as JAVA, Smalltalk, C#, C++, and Visual C++ or the like and conventional procedural programming languages, such as the C and Pascal programming languages or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may execute entirely on a user's computer, partly on the user's computer, as a stand-alone software package, partly on the user's computer and partly on a remote computer or entirely on a remote computer or server. Any such remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Aspects of the described invention may be implemented in one or more integrated circuit (IC) chips manufactured with semiconductor-fabrication processes. The maker of the IC chips can distribute them in raw wafer form (on a single wafer with multiple unpackaged chips), as bare die, or in packaged form. When in packaged form, the IC chip is mounted in a single chip package, for example, a plastic carrier with leads affixed to a motherboard or other higher level carrier, or in a multichip package, for example, a ceramic carrier having surface and/or buried interconnections. The IC chip is then integrated with other chips, discrete circuit elements, and/or other signal processing devices as part of either an intermediate product, such as a motherboard, or of an end product. The end product can be any product that includes IC chips, ranging from electronic gaming systems and other low-end applications to advanced computer products having a display, an input device, and a central processor.

Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It is be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

While the invention has been shown and described with reference to specific preferred embodiments, it should be understood by those skilled in the art that various changes in form and detail may be made therein without departing from the spirit and scope of the invention as defined by the following claims.

1. A method of selecting items from inventory for stocking a display in an enterprise, the method comprising:
receiving, over a network, a request from a user device to stock a store display in the enterprise with items;
ascertaining a type of the store display;
analyzing inventory to determine one or more types of items that are available in the inventory and suitable, based on one or more selection criteria and according to the ascertained type of the store display, for stocking the store display; and
sending a response to the request to the user device identifying, based on the analysis of the inventory and ascertained type of the store display, each type of item determined to be available in the inventory and suitable for stocking the store display.

2. The method of claim 1, wherein the one or more selection criteria require each type of item to be available in inventory in sufficient quantity to fill a target percentage of the store display in order for that type of item to be considered suitable for stocking the store display.

3. The method of claim 2, further comprising determining, for each type of item in inventory, whether that type of item is available in sufficient quantity to fill the target percentage of the store display by:
ascertaining a cubic volume for the type of the store display;
determining a quantity of items available in inventory for that type of item;
computing an aggregate cubic volume for that type of item based on the quantity of items available in inventory for that type of item; and
determining whether the aggregate cubic volume for that type of item can fill the target percentage of the cubic volume of the store display.

4. The method of claim 2, wherein the target percentage is 100 percent.

5. The method of claim 1, wherein the one or more selection criteria require a given type of items to be associated with a particular department of the enterprise in order for the given type of items to be suitable for stocking the store display.

6. The method of claim 1, wherein the one or more selection criteria require a given type of items to be associated with a particular category of products in order for the given type of items to be suitable for stocking the store display.

7. The method of claim 1, wherein the one or more selection criteria require a given type of items to have not been displayed for a certain period in order for the given type of items to be suitable for stocking the store display.

8. The method of claim 1, wherein the one or more selection criteria require a given type of items to be associated with a sales advantage in order for the given type of items to be suitable for stocking the store display.

9. The method of claim 1, wherein analyzing the inventory includes determining a feature score for each type of items in inventory.

10. The method of claim 9, wherein the one or more selection criteria require the feature score of a given type of items to meet a threshold value in order for the given type of items to be suitable for stocking the store display.

11. The method of claim 9, wherein the response to the request sent to the user device includes the feature score for each type of items determined suitable for stocking the store display.

12. The method of claim 9, wherein the feature score for a given type of items is a function of the cubic volume of the store display and an aggregate cubic volume associated with a quantity of available items in inventory for the given type of items.

13. The method of claim 9, wherein the feature score for a given type of items is a function of the cubic volume of the store display, a target fill percentage for the store display, and dimensions of individual items of the given type of items.

14. The method of claim 9, wherein the feature score for a given type of items is a function of whether the given type of items is involved in a pricing event.

15. The method of claim 9, wherein the feature score for a given type of items is a function of a sales increase forecast calculated for the given type of items.

16. The method of claim 9, wherein the feature score for a given type of items is a function of gross margin associated with the given type of items.

17. The method of claim 9, wherein the feature score for a given type of items is a function of quantity on-hand, any associated pricing events, estimated sales lift, and estimated profit lift for the given type of items.

18. The method of claim 9, wherein the feature score for a given type of items is a function of a location score for the given type of items.

19. The method of claim 9, wherein the feature score for a given type of items is a function of a forecast quality score for the given type of items.

20. The method of claim 1, wherein the request includes a combination of the type of display and zero, one, or more of the one or more selection criteria.

21. The method of claim 1, further comprising determining, for each type of item in inventory, whether that type of item will fit on the type of display by:
ascertaining the width, length and height of the type of display;
ascertaining the width, length and height of that type of item;
computing the number of facings and corresponding depth of each facing that are possible for the store display based on the ascertained width, length and height of that type of item.

22. The method of claim 21, wherein items whose dimensions exceed that of the type of display are excluded from recommendation.

23. A server system comprising:
memory storing a server application program for recommending items available in inventory suitable for stocking store displays in an enterprise;
a network interface receiving, over a network from a client device, a request to stock a store display;
a processor executing the server application program in response to the request, the server application program, when executed by the processor:
analyzing the inventory to determine one or more types of items that are available in the inventory and suitable, based on one or more selection criteria and according to an ascertained type of the store display, for stocking the store display; and
sending, through the network interface, a response to the request to the user device identifying, based on the analysis of the inventory and the ascertained type of the store display, each type of item determined to be available in the inventory and suitable for stocking the store display.

24. The server system of claim 23, wherein the one or more selection criteria require each type of item to be available in inventory in sufficient quantity to fill a target percentage of the store display in order for that type of item to be considered suitable for stocking the store display.

25. The server system of claim 24, wherein the server application program, when executed by the processor, determines, for each type of item in inventory, whether that type of item is available in sufficient quantity to fill the target percentage of the store display by:
ascertaining a cubic volume for the type of the store display;
determining a quantity of items available in inventory for that type of item;
computing an aggregate cubic volume for that type of item based on the quantity of items available in inventory for that type of item; and
determining whether the aggregate cubic volume for that type of item can fill the target percentage of the cubic volume of the store display.

26. The server system of claim 24, wherein the target percentage is 100 percent.

27. The server system of claim 23, wherein the one or more selection criteria require a given type of items to be associated with a particular department of the enterprise in order for the given type of items to be suitable for stocking the store display.

28. The server system of claim 23, wherein the one or more selection criteria require a given type of items to be associated with a particular category of products in order for the given type of items to be suitable for stocking the store display.

29. The server system of claim 23, wherein the one or more selection criteria require a given type of items to have not been displayed for a certain period in order for the given type of items to be suitable for stocking the store display.

30. The server system of claim 23, wherein the one or more selection criteria require a given type of items to be associated with a sales advantage in order for the given type of items to be suitable for stocking the store display.

31. The server system of claim 23, wherein the server application program, when executed by the processor, determines a feature score for each type of items in inventory when analyzing the inventory.

32. The server system of claim 31, wherein the one or more selection criteria require the feature score of a given type of items to meet a threshold value in order for the given type of items to be suitable for stocking the store display.

33. The server system of claim 31, wherein the response to the request sent to the user device includes the feature score for each type of items determined suitable for stocking the store display.

34. The server system of claim 31, wherein the feature score for a given type of items is a function of the cubic volume of the store display and an aggregate cubic volume associated with a quantity of available items in inventory for the given type of items.

35. The server system of claim 31, wherein the feature score for a given type of items is a function of whether the given type of items is involved in a pricing event.

36. The server system of claim 31, wherein the feature score for a given type of items is a function of a sales increase forecast calculated for the given type of items.

37. The server system of claim 31, wherein the feature score for a given type of items is a function of gross margin associated with the given type of items.

38. The server system of claim 31, wherein the feature score for a given type of items is a function of quantity on-hand, any associated pricing events, estimated sales lift, and estimated profit lift for the given type of items.

39. The server system of claim 31, wherein the feature score for a given type of items is a function of a location score for the given type of items.

40. The server system of claim 31, wherein the feature score for a given type of items is a function of a forecast quality score for the given type of items.

41. The server system of claim 31, wherein the request includes a combination of the type of display and zero, one, or more of the one or more selection criteria.

42. The server system of claim 31, wherein the server application program, when executed by the processor, determines, for each type of item in inventory, whether that type of item will fit on the type of display by:
ascertaining the width, length and height of the type of display;
ascertaining the width, length and height of that type of item;
computing the number of facings and corresponding depth of each facing that are possible for the store display based on the ascertained width, length and height of that type of item.

43. The server system of claim 42, wherein items whose dimensions exceed that of the type of display are excluded from recommendation.

44. Computer program product for selecting items from inventory for stocking a display in an enterprise, the computer program product comprising:
a computer readable storage medium having computer readable program code embodied therewith, the computer readable program code comprising:
computer readable program code configured, when executed by a processor, to receive, over a network, a request from a user device to stock a store display in an enterprise with items;
computer readable program code configured, when executed by a processor, to ascertain a type of the store display;
computer readable program code configured, when executed by a processor, to analyze inventory to determine one or more types of items that are available in the inventory and suitable, based on one or more selection criteria and according to the ascertained type of the store display, for stocking the store display; and
computer readable program code configured, when executed by a processor, to send a response to the request to the user device identifying, based on the analysis of the inventory and ascertained type of the store display, each type of item determined to be available in the inventory and suitable for stocking the store display.
